(19) United States
(12) Patent Application Publication
(10) Pub. No.: US 2007/0082236 A1
(43) Pub. Date: Apr. 12, 2007

(54) Catalyst for reforming fuel and fuel cell system comprising the same

(76) Inventors: Sung-Chul Lee, Suwon-si (KR); Ju-Yong Kim, Suwon-si (KR); Sang-Jun Kong, Suwon-si (KR); Dong-Yun Lee, Yongin-si (KR); Chan-Ho Lee, Suwon-si (KR); Dong-Myung Suh, Suwon-si (KR); Myeong-Ju Ha, Suwon-si (KR); Dong-Uk Lee, Suwon-si (KR)

Correspondence Address: CHRISTIE, PARKER & HALE, LLP, PO BOX 7068, PASADENA, CA, 91109-7068, US

(21) Appl. No.: 11/540,796

(22) Filed: Sep. 28, 2006

(30) Foreign Application Priority Data
Sep. 28, 2005 (KR) 10-2005-0090429

(51) Int. Cl. H01M 8/06

(52) U.S. Cl. 429/19; 502/305; 502/309; 502/324; 502/325; 502/349; 502/344; 502/340; 502/353

(57) ABSTRACT

A catalyst for reforming a fuel and a fuel cell system including the same is provided. The catalyst for reforming a fuel includes at least one active metal selected from the group consisting of titanium (Ti), iron (Fe), chromium (Cr), nickel (Ni), cobalt (Co), vanadium (V), tungsten (W), molybdenum (Mo), manganese (Mn), tin (Sn), ruthenium (Ru), aluminum (Al), platinum (Pt), silver (Au), palladium (Pd), copper (Cu), rhodium (Rh), zinc (Zn), and mixtures thereof, supported on a metal foam, and a fuel cell system in which butane is used as a fuel, also including the same catalyst composition as a reforming catalyst for use in a reformer.

### CROSS-REFERENCE TO RELATED APPLICATION

This application claims priority to and the benefit of Korean Patent Application No. 10-2005-0090429 filed in the Korean Intellectual Property Office on Sep. 28, 2005, the entire content of which is incorporated herein by reference.

### FIELD OF THE INVENTION

The present invention relates to a catalyst for reforming a fuel and a fuel cell system including the same. More particularly, the present invention relates to a catalyst for reforming a fuel having excellent reforming activity at high temperatures.

### BACKGROUND OF THE INVENTION

A fuel cell is a power generation system for generating electrical energy through an electrochemical reaction of hydrogen contained in a hydrocarbon-based material such as methanol, ethanol, natural gas, and the like, and oxygen or oxygen-included air.

Butane, rather than methanol and ethanol may be used as the fuel which supplies hydrogen. However, since the butane reforming reaction should be carried out at a comparatively high temperature of 600° C. or more, a lot of heaters are mounted in the reformer, and it is difficult to supply the gas flux in sufficient amounts. The temperatures required to reform butane are higher than those for reforming methanol, which are typically 220 to 270° C. Problems occur in that the energy efficiency is decreased, and the reforming catalyst is deteriorated during the reforming reaction.

In addition, it is difficult to provide a compact reformer due to the additional heating devices required to maintain the reforming temperature since a conventional heater cannot provide such reforming temperatures to the reformer.

### SUMMARY OF THE INVENTION

One embodiment of the present invention provides a catalyst for reforming a fuel in which the activity of reforming butane to hydrogen is increased so that the temperature and the pressure of the reforming reaction are lower compared to those of the conventional reaction, and the conversion rate of butane to hydrogen and the durability are improved to prevent the deterioration of the catalyst.

Another embodiment of the present invention provides a fuel cell system including the catalyst for reforming the fuel to increase the lifespan and the efficiency thereof.

According to one embodiment of the present invention, a catalyst for reforming a fuel is provided that includes an active metal supported on a metal foam. The catalyst is suitable for reforming butane.

The active metal may include at least one selected from the group consisting of nickel (Ni), ruthenium (Ru), titanium (Ti), iron (Fe), chromium (Cr), cobalt (Co), manganese (Mn), tin (Sn), aluminum (Al), platinum (Pt), silver (Ag), palladium (Pd), copper (Cu), rhodium (Rh), and mixtures thereof.

According to another embodiment of the present invention, a fuel cell system is provided that includes: an electricity generating element generating electrical energy by an electrochemical reaction of an oxidation reaction of hydrogen and a reduction reaction of an oxidant; a reformer generating hydrogen from a fuel via a chemical catalyst reaction and providing the hydrogen to the electricity generating element; a fuel supplier providing the fuel to the reformer; and an oxidant supplying element providing the oxidant to the electricity generating element. The catalyst for reforming a fuel is present inside of the reforming reaction section.

### BRIEF DESCRIPTION OF THE DRAWINGS

FIG. 1 is a schematic diagram showing a catalyst according to one embodiment of the present invention.

FIG. 2 is a schematic block diagram showing a fuel cell system according to one embodiment of the present invention,

FIG. 3 is an exploded perspective view showing a stack structure for a fuel cell system according to an embodiment of the present invention.

### DETAILED DESCRIPTION

According to an embodiment of the present invention, the reforming catalyst is a catalyst where an active metal is supported on a metal foam to increase the activity for reforming a fuel, especially butane to hydrogen so that the temperature and the pressure of the reforming reaction are decreased. In addition, the conversion rate of a fuel to hydrogen and the durability are improved to prevent the self-deterioration of the catalyst so that the lifespan and the efficiency of the reformer and the fuel cell system are improved.

According to the fuel cell system of one embodiment of the present invention, butane is substantially used as a fuel and reformed to generate hydrogen that is electrochemically reacted with an oxidant to generate electrical energy.

In one embodiment, the hydrogen generation from butane occurs in accordance with a steam reforming reaction (SR reaction) shown in the following Reaction Scheme 1. Gaseous butane is subject to a reaction with water vapor under the presence of a reforming catalyst at a high temperature of 600° C. or more.
C₄H₁₀+H₂O→H₂+CO₂+CO+CH₄ (1)

In another embodiment, the resultant CO gas from Reaction Scheme 1 is reacted with water vapor to generate carbon dioxide and hydrogen so that the amount of CO gas is minimized in the reforming gas, as in the Reaction Scheme 2.
CO+H₂O→CO₂+H₂ (2)

The reforming reaction at a high temperature deteriorates the reforming catalyst so that the efficiency and the lifespan of the reformer and the fuel cell system are deteriorated.

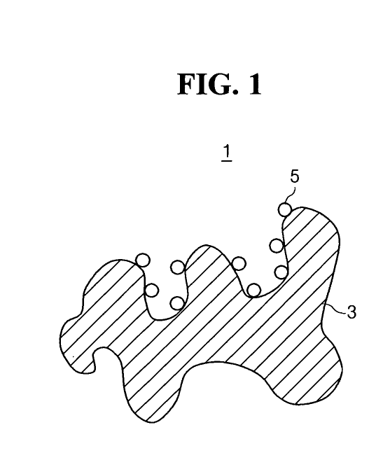

FIG. 1 is a schematic diagram showing one embodiment of a catalyst for reforming a fuel according to the present invention. As shown in FIG. 1, the catalyst 1 includes an active metal 5 supported on a metal foam 3.

The metal foam is a porous metal having a lot of pores inside of the metal substance, is very light, and has a very high surface area per unit volume. Particularly, the metal foam can carry an active metal in the pores to maximize the efficiency of the catalyst surface and to improve the thermal conductivity, the strength, and the durability so that it is not deteriorated upon the reforming reaction at high temperatures of 600° C. or more.

In one embodiment, the materials useful for the metal foam may include any material known by the person of ordinary skill in this art, and in particular may be aluminum, nickel, copper, silver, and an alloy thereof, or stainless steel. In another embodiment, the metal foam includes a stainless steel material. A catalyst forming process is one of the most difficult and time consuming processes among the processes for manufacturing a catalyst. However, one embodiment of the present invention omits the forming process from the processes for manufacturing the catalyst by using the above-mentioned metal foam so that the processes may be easier.

According to one embodiment of the present invention, the metal foam may have a porosity of between about 40 and about 98%, and a pore density of between about 400 and about 1200 ppi (pore number per inch) in order to support a sufficient amount of an active metal. According to one embodiment of the present invention, the porosity of the metal foam may ranges from 50 to 90%. When the porosity of the metal foam has a porosity of 55%, 60%, 65%, 70%, 75%, 80%, or 85%, the lifespan and the efficiency of the reformer and the fuel cell system can be improved.

In one embodiment, its surface is treated with a metal oxide to facilitate supporting an active metal. Such metal oxide may include, but is not limited to, aluminum oxide, iron oxide (Fe₂O₃), chromium oxide, and so on. The surface treatment of the metal oxide may include, but is not limited to, coating with a metal oxide or heating the metal foam under air. The porosity, the pore density, and the amount of the metal oxide for the surface treatment may be adjusted in accordance with the required supporting amount and the particulate size of the active metal. In one embodiment, the metal oxide is surface-treated in an amount of about 0.5 to about 10 wt % based on the total weight of the metal foam.

In one embodiment, the active metal supported on the metal foam may include, but is not limited to, any metal as long as it has catalyst activity, and may be at least one metal selected from the group consisting of titanium (Ti), iron (Fe), chromium (Cr), cobalt (Co), manganese (Mn), tin (Sn), aluminum (Al), platinum (Pt), silver (Au), palladium (Pd), copper (Cu), rhodium (Rh), and alloys thereof.

In one embodiment, the amount of the active metal supported on the metal foam is between about 0.5 and about 20 parts by weight based on 100 parts by weight of the metal foam. According to one embodiment, the amount of the active metal supported on the metal foam is between about 1.0 and about 10 parts by weight based on 100 parts by weight of the metal foam. In order to adjust the supporting amount, the metal foam is selected to have a suitable pore density and particle diameter thereof. The reforming catalyst is activated when the supporting amount is more than the 0.5 parts by weight, but the cost is excessively increased when it is more than 20 parts by weight.

In one embodiment, the catalyst supported with the active metal in the metal foam may be provided in any process known in the art as well as the process disclosed in the present invention, such as a sol-gel coating, a wash coating, a chemical deposition, a physical deposition, and an ion plating. According to one embodiment, a wash coating may be advantageously preformed.

In an embodiment, the wash coating includes the steps of a) preparing a catalyst slurry including an active metal precursor, b) treating a metal foam with acid, c) wash coating the surface of the acid-treated metal foam prepared from step b) with the catalyst slurry prepared from step a) and drying it, and d) firing the same.

In another embodiment, the catalyst slurry of step a) is prepared by dissolving a precursor of a metal selected from the group consisting of nickel, ruthenium, titanium, iron, chromium, cobalt, vanadium, tungsten, molybdenum, manganese, tin, aluminum, platinum, silver, palladium, copper, rhodium, zinc, and mixtures thereof into water or an organic solvent in a predetermined concentration. In one embodiment, the precursor may include, but is not limited to, halides such as chloride or fluoride, nitrate, sulfate, acetates of the active metal and mixtures thereof, and a mixture of precursors of different active metals.

In an embodiment, the acid-treating step of step b) is carried out to increase adherence strength between the metal foam and the active metal. That is, the metal ion present on the surface of the metal foam is eluted by the acid treatment, and an active metal is positioned on the site where the metal ion is eluted to stably coat the surface of the metal foam with the active metal. In one embodiment, the employable acid is a strong acid and the metal foam is immersed in an aqueous solution of hydrochloric acid, sulfuric acid, and nitric acid in about 0.1 to about 1.0 M concentration for 1 minute to 1 hour to activate the surface of the metal foam.

According to one embodiment, in step c), the metal foam treated with the acid is immersed in the catalyst slurry of step a) for 3 to 12 hours in order to support a sufficient amount of catalyst slurry in the metal foam pore. Then, the metal foam coated with the catalyst slurry is dried for at least 12 hours at room temperature to coat the metal foam pore with the active metal.

According to an embodiment, inn step d), the metal foam provided from step c) is fired at 500 to 700° C. to provide a catalyst where the active metal is supported on the metal foam according to the present invention. The amount of catalyst supported on the metal foam is adjusted by controlling the concentration of the catalyst slurry or the number of repeated times of carrying out the wash coating processes.

According to the present invention, the catalyst including the active metal supported on the metal foam is applicable for a reforming catalyst for a fuel cell system. According to one embodiment of the present invention, butane is used for a fuel. Thereby, the activity of reforming a fuel to hydrogen is increased at a lower temperature of the reforming reaction, which is conventionally carried out at a higher temperature. Further, since the catalyst according to the present invention has a foam structure different from the conventional pallet or spherical structure, the active metal is ensured to be contained in the entire catalyst, including the inner spaces thereof. Thereby, the conversion rate of a fuel to hydrogen is improved and the injection of a fuel is at a lower pressure in the reactor. In addition, the conversion rate of a fuel to hydrogen and the durability are improved to prevent the deterioration of the catalyst and to improve the lifespan and the efficiency of the reformer and the fuel cell system.

An embodiment of the present invention will hereinafter be described in detail with reference to the accompanying drawings. However, the present invention may have various modifications and equivalent arrangements and it is to be understood that the invention is not limited to the described embodiments

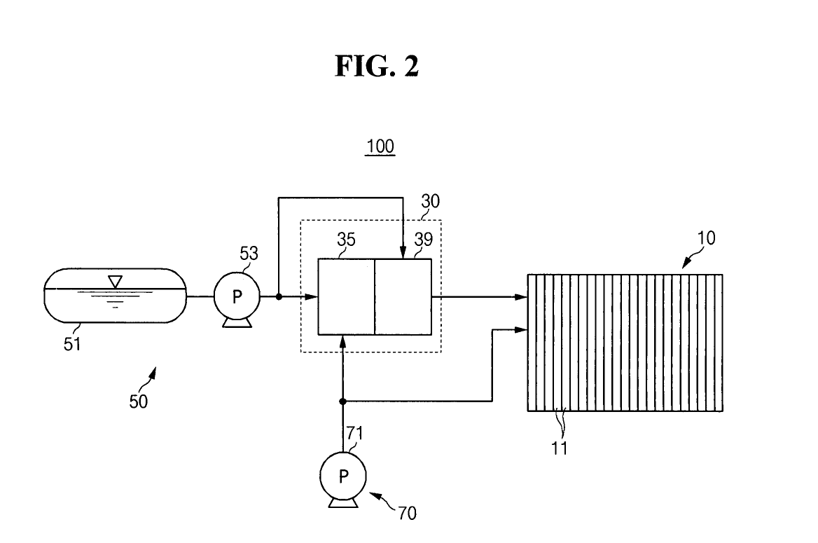

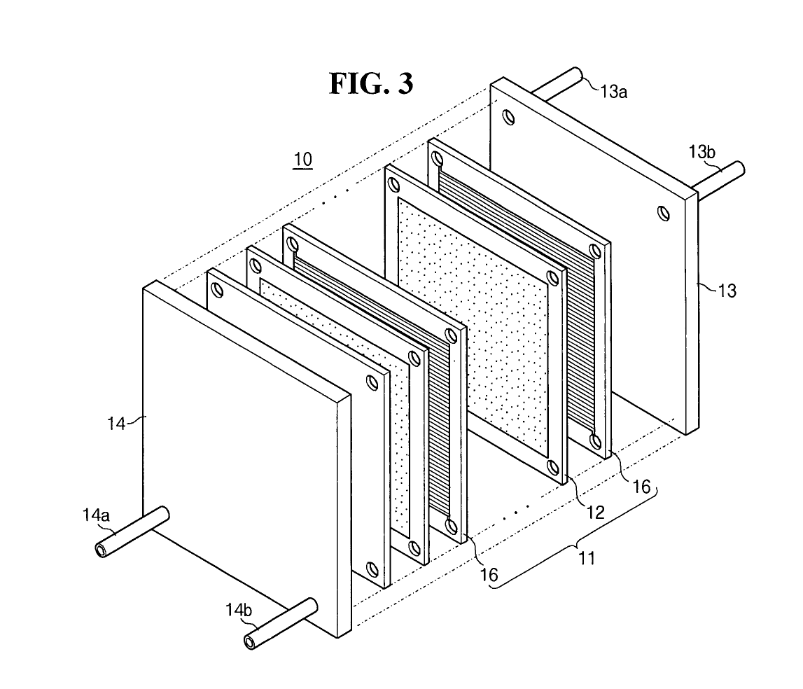

FIG. 2 is a schematic diagram showing a fuel cell system according to one embodiment of the present invention, and FIG. 3 is an exploded perspective view showing the stack structure illustrated in FIG. 2.

According to an embodiment of the present invention and in reference to the drawings, a fuel cell system 100 includes: an electricity generating element 11 generating electrical energy by inducing an oxidation/reduction reaction of a reforming gas reformed from a reformer 30 and an oxidant; a fuel supplier 50 providing a fuel to the reformer 30; the reformer 30 reforming the fuel to generate hydrogen to provide the hydrogen to the electricity generating element 11; and an oxidant supplying element 70 providing the oxidant to the reformer 30 and the electricity generating element 11.

As shown in FIG. 3, the electricity generating element 11 is formed as a minimum fuel cell unit for generating electricity by disposing a membrane-electrode assembly (MEA) 12 between two separators 16 (or bipolar plates). Then, a stack 10 is formed with a stacked structure by arranging a plurality of minimum units of electricity generating elements 11.

The membrane-electrode assembly 12 has an active area with a predetermined area incurring the electrochemical reaction via the oxidation reaction of hydrogen and the reduction reaction of oxygen. An anode and a cathode are respectively disposed on each side and an electrolyte membrane is interposed between the two electrodes. The anode acts to transform hydrogen to protons and electrons by oxidizing the hydrogen. The cathode acts to generate heat at a predetermined temperature and water by reducing the protons and oxygen. Further, the electrolyte membrane has the function of an ion-exchanger moving the protons produced in the anode to the cathode. Additionally, the separators 16 have the functions of conductors connecting the anode to the cathode in series and of providing hydrogen and oxygen to respective sides of the membrane-electrode assembly 12.

The stack 10 can additionally include pressing plates 13 and 14, for positioning a plurality of the electricity generating elements 11 to be closely adjacent to each other, at the outermost ends of the stack 10. However, the stack 10 of a fuel cell according to an embodiment can be formed by using the separators 16 at the outermost ends of the plurality of electricity generating elements 11 to play the role of pressing the electricity generating elements 11 instead of using the separate pressing plates 13 and 14.

The pressing plate 13 has a first inlet 13a to supply hydrogen gas into a hydrogen passage path of the separator 16 and a second inlet 13b to supply air into an air passage path of the separator 16. The pressing plate 14 has a first outlet 14a to release hydrogen gas remaining after a reaction at the anode of the membrane-electrode assembly 12, and a second outlet 14b to release air remaining after reacting with hydrogen and moisture generated through a reduction reaction of oxygen at the cathode of the membrane-electrode assembly 12.

The reformer 30 generates hydrogen from the hydrogen-included fuel by a catalyst reaction such as a chemical catalyst reaction due to the heating energy, for example a steam reforming reaction, a partial oxidation, or an autothermal reaction, and supplies the generated hydrogen to the stack 10. The reformer 30 is connected with the stack 10 and the fuel supplier 50 via a pipe line and so on.

The fuel supplier 50 includes a fuel tank 51 containing the fuel to be supplied to the reformer 30 and a fuel pump 53 connecting with the fuel tank 51 and releasing the fuel from the fuel tank 51. The fuel tank 51 is connected with a heater 35 of the reformer 30 and a reforming reactor 39 via pipe lines.

The oxidant supplier 70 includes an air pump 71 drawing in an oxidant by a predetermined pumping force and supplying the oxidant to the electricity generating elements 11 of the stack 10 and the heater 35. The oxidant supplied to the electricity generating elements 11 includes a gas reacting with hydrogen, for example oxygen or air containing oxygen stored in a separate storage space. According to an embodiment as shown in the drawing, the oxidant supplying element 70 is illustrated to supply the oxidant to the stack 10 and the heater 35 via a single air pump 71, but is not limited thereto. It may include a pair of air pumps mounted to the stack 10 and the heater 35 respectively.

Upon driving the system 100 according to one embodiment of the present invention, hydrogen generated from the reformer 30 is supplied to the electricity generating elements 11, and the oxidant is supplied to the electricity generating elements 11, and thereby the electrochemical reaction occurs by the oxidation reaction of the hydrogen and the reduction reaction of the oxidant to generate electrical energy as well as water and heat. Such a fuel cell system 100 can be a power source for supplying a predetermined electrical energy to any load such as a portable electronic device including a laptop computer and a PDA or a mobile telecommunication device.

Further, the fuel cell system 100 may substantially control the overall driving of the system such as the driving of the fuel supplier 50 and the oxidant supplying element 70 by a general control unit (not shown) separately mounted.

Particularly, the fuel cell system 100 according to the present invention uses butane as a substantial fuel. The butane is stored in a fuel supplier 50 in a gas or liquid state and is supplied to the reformer 30 in a gas state. Further, it may selectively include a desulfurizer between the fuel supplier 50 and the reformer 30 to remove the sulfur component from the butane fuel.

According to one embodiment of the present invention, the reformer 30 may include the heater 35 generating the predetermined heating energy required for the reforming reaction of butane by the oxidation catalyst reaction between the butane fuel and the oxidant respectively supplied from the fuel supplier 50 and the oxidant supplying element 70, and a reforming reactor 39 absorbing the heating energy generated from the heater 35 to generate hydrogen from the butane fuel via the reforming catalyst reaction of butane supplied from the fuel supplier 50. The heater 35 of the reformer 30 and the reforming reactor 39 may be independently equipped and connected to each other via a common connection element. Alternatively, they may be incorporated in a double pipeline where the heater 35 is disposed inside and the reforming reactor 39 is disposed outside.

The insides of the heater 35 and the reforming reactor 39 of the reformer 30 are respectively filled with the oxidation catalyst and the reforming catalyst to carry out the oxidation and the reforming reactions. Further, the reforming catalyst includes a metal foam supported with an active metal.

When the reformer 30 generates hydrogen from the hydrogen-included fuel by an autothermal catalytic reaction, the heater 35 is not necessary.

From the result, as the reforming activity of butane is improved to increase the activity of reforming butane to hydrogen, it is possible to decrease the temperature and the pressure of the reforming reaction that has conventionally been carried out at a high temperature and high pressure. Furthermore, the conversion rate of butane to hydrogen and the durability are improved to prevent the self-deterioration of the catalyst and thus improve the lifespan and efficiency of the reformer and the fuel cell system.

In the above description, the fuel system using butane as a fuel is described, but the present invention is not limited to butane fuel. The fuel cell system can be applicable to reforming of all fuels. The fuel includes liquid or gaseous hydrogen, or a hydrocarbon-based fuel such as methanol, ethanol, propanol, butanol, or natural gas.

The following examples illustrate the present invention in more detail. However, it is understood that the present invention is not limited by these examples.

### EXAMPLES

### Example 1

100 g of nickel chloride was dissolved into 1 L of water to provide a catalyst slurry.

Then, stainless steel metal foam (porosity 55%, pore density 400 ppi) was treated with 1 M hydrochloric acid to activate a surface thereof, and thereafter immersed into the catalyst slurry and agitated for 5 hours at room temperature.

The metal foam was removed from the catalyst slurry and dried for 15 hours at room temperature, then fired at 500° C. to provide a catalyst for reforming a fuel.

### Example 2

A catalyst for reforming a fuel was fabricated according to Example 1 except that 100 g of ruthenium chloride was used instead of 100 g of nickel chloride.

### Example 3

A catalyst for reforming a fuel was fabricated according to Example 1 except that 50 g of ruthenium chloride and 50 g of rhodium chloride were used instead of 100 g of nickel chloride.

### Example 4

100 g of nickel chloride was dissolved into 1 L of water to prepare a catalyst slurry.

A stainless steel metal foam (porosity 55%, pore density 400 ppi) was heated at a temperature of 500° C. with flowing air to provide a metal foam of which the surface is treated with a metal oxide. It was immersed in the catalyst slurry and agitated at room temperature for 5 hours.

Then, the metal foam was removed from the catalyst slurry and dried at room temperature for 15 hours and then fired at 500° C. to provide a catalyst for reforming a fuel.

### Example 5

A catalyst for reforming a fuel was fabricated according to Example 4 except that 100 g of ruthenium chloride was used instead of 100 g of nickel chloride, and aluminum metal foam was used instead of stainless steel metal foam.

### Example 6

A catalyst for reforming a fuel was fabricated according to Example 4 except that 50 g of platinum chloride and 50 g of rhodium chloride were used instead of 100 g of nickel chloride, and aluminum metal foam was used instead of stainless steel metal foam.

### Experimental Example 1

In order to evaluate the activity of the catalysts for reforming the fuel provided from Examples 1 to 6, a test for reforming butane was carried out. In this case, the conversion rate of hydrogen was measured by varying the reaction temperature, the pressure, and the supporting amount. The results of the catalysts according to Examples 1, 5, and 6 are shown in the following Tables 1 to 3.

TABLE 1

| | Reaction | Reaction | Supporting | Butane | Hydrogen |
|---|---|---|---|---|---|
| | temperature | pressure | amount | conversion | selectivity |
| No. | (° C.) | (atm) | (wt %) | rate (%) | (%) |
| 1 | 600 | 1 | 13 | 75 | 56 |
| 2 | 700 | 1 | 13 | 93 | 70 |
| 3 | 800 | 1 | 13 | 95 | 72 |
| 4 | 700 | 1 | 10 | 92 | 65 |
| 5 | 700 | 1 | 15 | 95 | 71 |
| 6 | 700 | 1 | 18 | 95 | 73 |

TABLE 2

| | Reaction | Reaction | Supporting | Butane | Hydrogen |
|---|---|---|---|---|---|
| | temperature | pressure | amount | conversion | selectivity |
| No. | (° C.) | (atm) | (wt %) | rate (%) | (%) |
| 1 | 600 | 1 | 2 | 68 | 48 |
| 2 | 650 | 1 | 2 | 85 | 71 |
| 3 | 700 | 1 | 2 | 96 | 75 |
| 4 | 750 | 1 | 2 | 97 | 73 |
| 5 | 700 | 1 | 1 | 93 | 74 |
| 6 | 700 | 1 | 0.5 | 82 | 70 |

TABLE 3

| | Reaction | Reaction | Supporting | Butane | Hydrogen |
|---|---|---|---|---|---|
| | temperature | pressure | amount | conversion | selectivity |
| No. | (° C.) | (atm) | (wt %) | rate (%) | (%) |
| 1 | 600 | 1 | 2 | 64 | 42 |
| 2 | 650 | 1 | 2 | 75 | 61 |
| 3 | 700 | 1 | 2 | 92 | 73 |
| 4 | 750 | 1 | 2 | 97 | 75 |
| 5 | 750 | 1 | 1 | 95 | 71 |
| 6 | 750 | 1 | 0.5 | 86 | 70 |

Referring to Tables 1 to 3, the conversion rate of butane and the hydrogen selectivity are increased by increasing the reaction temperature, and thereby the catalyst activity is remarkably improved. Further, the conversion rate of butane and the hydrogen selectivity are slightly increased when the supporting amount is increased.

The reformer of the fuel cell system according an embodiment of the present invention, in which butane is used as a fuel, includes an active metal supported on a metal foam, the activity for reforming butane to hydrogen is increased so that the reforming reaction can be carried out at a lower temperature and pressure than those of a conventional system. Further, the conversion rate of a fuel to hydrogen and the durability are improved to prevent the deterioration thereof so that the lifespan and the efficiency of the reformer and the fuel cell system are improved.

While this invention has been described in connection with exemplary embodiments, it is to be understood that the invention is not limited to the disclosed embodiments, but, on the contrary, is intended to cover various modifications and equivalent arrangements included within the spirit and scope of the appended claims.

What is claimed is:

1. A catalyst for reforming a fuel comprising:
a metal foam; and
an active metal selected from the group consisting of titanium (Ti), iron (Fe), chromium (Cr), nickel (Ni), cobalt (Co), vanadium (V), tungsten (W), molybdenum (Mo), manganese (Mn), tin (Sn), ruthenium (Ru), aluminum (Al), platinum (Pt), silver (Au), palladium (Pd), copper (Cu), rhodium (Rh), zinc (Zn), and mixtures thereof, supported on the metal foam.

2. The catalyst for reforming a fuel according to claim 1, wherein the metal foam has a porosity of between about 40 and about 98%

3. The catalyst for reforming a fuel according to claim 1, wherein the metal foam has a pore density of between about 400 and about 1200 ppi.

4. The catalyst for reforming a fuel according to claim 1, wherein the metal foam supports an active metal selected from the group consisting of aluminum (Al), nickel (Ni), copper (Cu), silver (Ag), alloys thereof, stainless steel, and combinations thereof.

5. The catalyst for reforming a fuel according to claim 1, wherein the active metal is present in the range of about 0.5 to about 20 parts by weight based on 100 parts by weight of the metal foam.

6. The catalyst for reforming a fuel according to claim 1, wherein the surface of the metal foam is treated with a metal oxide.

7. A fuel cell system comprising:
an electricity generating element adapted to generate electrical energy by the electrochemical reaction of an oxidation reaction of hydrogen and the reduction reaction of an oxidant;
a reformer adapted to generate the hydrogen from a fuel via a chemical catalyst reaction and providing the hydrogen to the electricity generating element;
a fuel supplier adapted to provide the fuel to the reformer; and
an oxidant supplier adapted to provide the oxidant to the electricity generating element,
wherein the reformer comprises a catalyst comprising:
a metal foam; and
an active metal selected from the group consisting of titanium (Ti), iron (Fe), chromium (Cr), nickel (Ni), cobalt (Co), vanadium (V), tungsten (W), molybdenum (Mo), manganese (Mn), tin (Sn), ruthenium (Ru), aluminum (Al), platinum (Pt), silver (Au), palladium (Pd), copper (Cu), rhodium (Rh), zinc (Zn), and mixtures thereof, supported on the metal foam.

8. The fuel cell system according to claim 7, wherein the reformer is coated with or filled with the catalyst.

9. The fuel cell system according to claim 7, wherein the metal foam has a porosity of between about 40 and about 98%

10. The fuel cell system according to claim 7, wherein the metal foam has a pore density of between about 400 and about 1200 ppi.

11. The fuel cell system according to claim 7, wherein the metal foam supports an active metal selected from the group consisting of aluminum (Al), nickel (Ni), copper (Cu), silver (Ag), alloys thereof, stainless steel, and combinations thereof.

12. The fuel cell system according to claim 7, wherein the catalyst comprises an active metal present in the range of about 0.5 to about 20 parts by weight based on 100 parts by weight of the metal foam.

13. The fuel cell system according to claim 7, wherein the surface of the metal foam is treated with a metal oxide.
